(19) United States
(12) Patent Application Publication
(10) Pub. No.: US 2003/0072924 A1
(43) Pub. Date: Apr. 17, 2003

(54) Sandwiched scrapable layer structure and method for making the same

(75) Inventor: David Kuang-Lin Wang, Taipei (TW)

Correspondence Address: Dongherty & Troxell, ONE SKYLINE PLACE, 5205 LEESBURG PIKE. SUITE 1404, FALLS CHURCH, VA, 22041, US

(73) Assignee: Foremost Office Supplies Corp.

(21) Appl. No.: 10/219,344

(22) Filed: Aug. 16, 2002

(30) Foreign Application Priority Data
Oct. 17, 2001 (TW) 90125649

(51) Int. Cl. B32B 27/14

(52) U.S. Cl. 428/195; 427/258

(57) ABSTRACT

A sandwiched scrapable layer structure and a method for making the same, the method includes the following steps: a first scrapable layer is coated on the card carrier at a reserved position of the carrier; information is printed on the first scrapable layer; a computer automatically detects and checks the information; a second scrapable label-layer is stuck on the first scrapable layer to cover the information, whereby a card structure with the confidential information sandwiched between the first and the second scrapable layers is obtained for improving confidentiality or safety without additional manufacturing or production costs.

### BACKGROUND OF THE INVENTION

1. Field of the Invention

The present invention is related to a sandwiched scrapable layer structure and a method for making the same which keep safety of confidential information from leaking out, and especially to such a layer structure applicable to prepaid cards for mobile phones or related confidential information.

2. Description of the Prior Art

Dealing with secret codes of accounts on cards is a very confidential operation, every account number represents a valuable monetary amount, the conventional mode of printing has account numbers arranged and printed in a whole card board not yet cut, and a scrapable film is coated thereon, then the card board is cut into separated cards. During the process of such arranging operation, account numbers still may be seen by operators, it is hard to control quality of confidentiality dependent on the virtue of the operators and leads to inferior effect of confidentiality and ineffective management.

Relatively advanced production ways of cards presently have the processes from arranging and printing till scrapable film coating done in a filly automatic supervising and control mode, the cut cards are automatically arranged to give serial numbers, spraying printed and immediately sealed with a film by a computer once they get in a card printing device, so that in such card production, serial numbers can be given by the completely automated operation without human intervene or manual work for improving confidentiality.

Besides, a conventional card with confidential information, such as a supplementary card of a telephone prepaid card, is manufactured in the way such as shown in FIG. 1: firstly, data “B” are sprayed onto the surface “A” of a paper, and a scrapable film layer “C” is directly coated on the data “B”; after the cards are cut, manufacturing the cards is completed. In use it needs only to scrape off the scrapable film “C”, the data “B” is obtained. However, with such a structure, if the force exerting on the scrapable film is overly large, the data “B” will be scraped off together with the scrapable film “C”; and more, the conventional mode shown in FIG. 1 tends to be intently and shallowly cut by a person with a knife along the outer rim of the scrapable film on the surface of the card to make raising of the surface and the film, then the secrete code therein is stolen by seeing the code through the left transparent layer under a light, and afterwards, the surface and the film are stuck back and the cut trace is embellished with a silver powder pen, and then the card is sold.

To get rid of the defect that the data “B” on the card surface “A” tends to be scraped off together with the scrapable film “C”, another structure is developed, referring to FIG. 2, another scrapable label film layer “D” is stuck on the data “B” on the card surface “A”, and the scrapable film “C” is coated on the transparent tape label, thereby, the scrapable film “C” is coated on the scrapable label film “D” rather than on the data “B”, in this way, the data “B” can avoid being scraped off together with the scrapable film “C” when the latter is to be scraped off, such a structure can get rid of the defect of scraping off the data “B”.

However, the prepaid card structure as shown in FIG. 2 still has the following defect of being subjected to stealing of a code: in such a structure, the scrapable film “C” and the scrapable label film “D” can be raised together only by a slight scratch done with a knife blade on the scrapable film “C”, and then the scrapable film “C” and the scrapable label film “D” are struck back after reading the data “B”, hence the secret of the data “B” is lost, and a user purchasing the card surface “A” can not really use the data “B”, that is to say, the right of the purchaser is infringed, and this is the largest defect of such cards.

### SUMMARY OF THE INVENTION

The primary object of the present invention is to provide a sandwiched scrapable layer structure and a method for making the same to keep confidential information in a safe and secret protection.

The secondary object of the present invention is to provide a sandwiched scrapable layer structure and a method for making the same suitable for any original specific card printing device without additional costs of manufacturing equipment.

To achieve the above objects, the method of the present invention includes the following steps:

1. a first scrapable layer in a form of scrapable materials or film is coated on the card carrier at a reserved position of the carrier;

2. information is printed on the first scrapable layer;

3. a computer automatically detects and checks the information; and

4. a second scrapable layer with scrapable materials or film, e.g. adhesives, in a label-layer form is stuck on the first scrapable layer to cover the information.

By the above steps, a tightly sealed card structure with the information sandwiched between the first and the second scrapable layers is obtained, thereby, safety or confidentiality for the information is improved without additional costs of production by using same equipment. Further, either the label piece is prevented from being peeled off or the confidential information, e.g. PIN code (Personal Identity Number), is well protected from being revealed. Only bona-fide owner of card can get the top scrapable layer peeled off to reveal the inside information.

The present invention will be apparent after reading the detailed description of the preferred embodiment thereof in reference to the accompanying drawings.

### BRIEF DESCRIPTION OF THE DRAWINGS

FIG. 1 is a schematic view showing use of a conventional confidential information-keeping card;

FIG. 2 is a perspective schematic view showing the structure of another conventional confidential information-keeping card;

FIG. 3 is a block diagram showing the processing chart;

FIG. 4 is a perspective view showing the first step of the present invention;

FIG. 5 is a perspective view showing the second step of the present invention;

FIG. 6 is a perspective view showing the third step of the present invention;

FIG. 7 is a perspective view showing the fourth step of the present invention;

FIG. 8 is an exploded perspective view of an embodiment of the present invention; and

FIG. 9 is a schematic perspective view showing a lower anti-seeing through scrapable layer of the embodiment of the present invention.

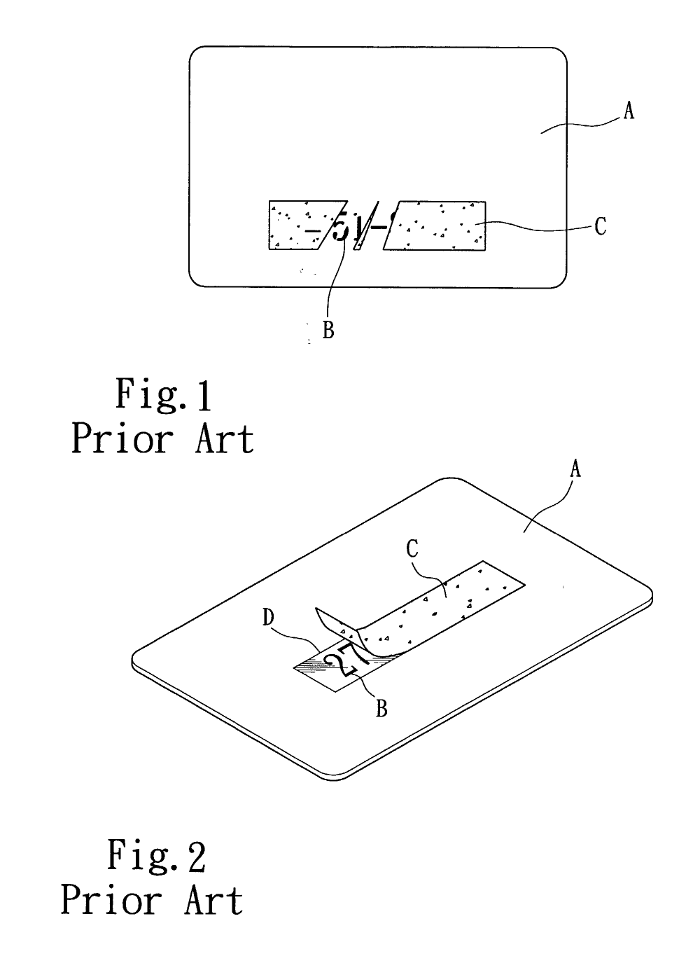

### DETAILED DESCRIPTION OF THE PREFERRED EMBODIMENT

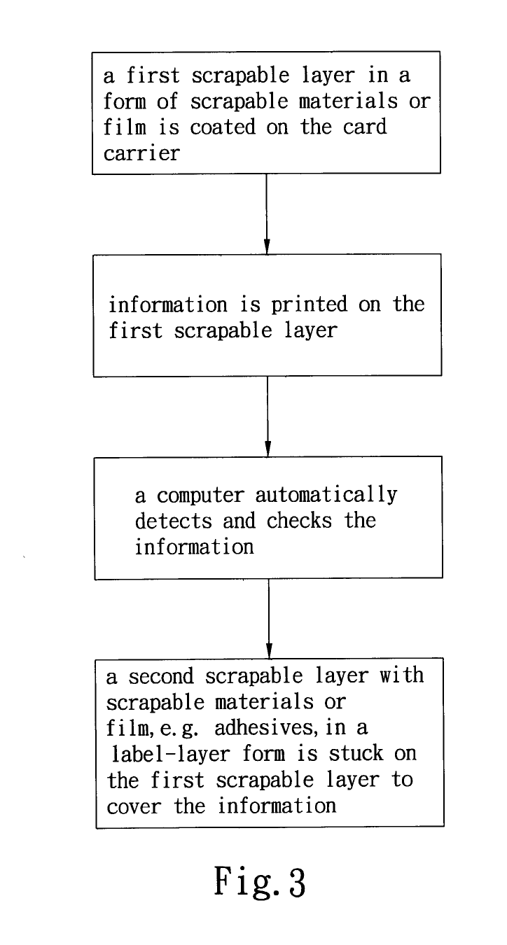

Referring to FIG. 3, the method of the present invention includes the following steps:

1. a first scrapable layer in a form of scrapable materials or film is coated on the card carrier at a reserved position of the carrier;

2. information is printed on the first scrapable layer;

3. a computer automatically detects and checks the information; and

4. a second scrapable layer with scrapable materials or film, e.g. adhesives, in a label-layer form is stuck on the first scrapable layer to cover the information.

As stated above, the information is tightly sealed and sandwiched between the first and the second scrapable layers, thereby safety or confidentiality for the information is improved without additional production costs by using same equipment.

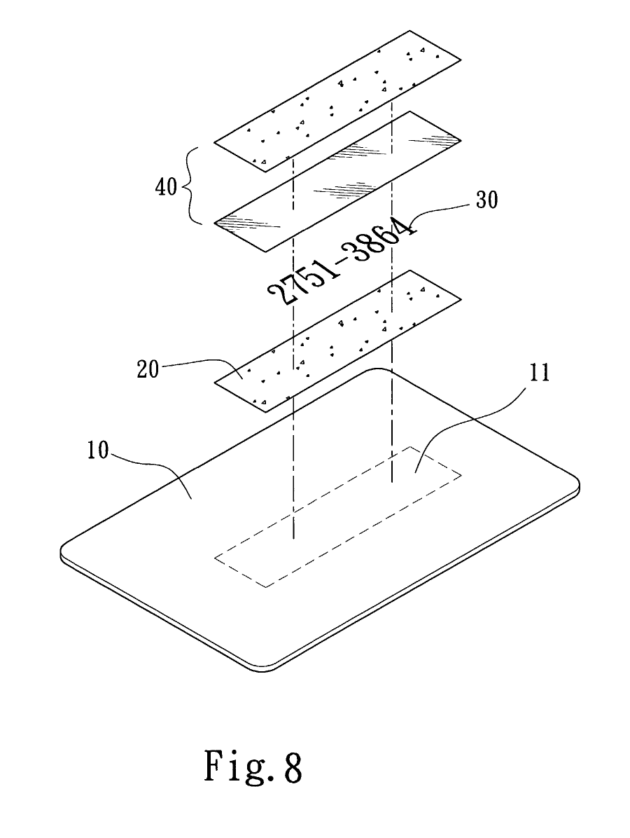

Referring to FIG. 8, the sandwiched scrapable layer structure is obtained by the aforesaid steps, the structure includes mainly: a card carrier 10 with a reserved position 11 for a scrapable layer; a lower scrapable layer 20 having an obscure surface to be directly coated on the reserved position 11 for a scrapable layer; a confidential information 30 printed on the lower scrapable layer 20; an upper scrapable label-layer 40 which is a transparent adhesive tape with an obscure surface for covering the confidential information 30 and covering the top of the reserved position 11. Thereby, the information is tightly sealed and sandwiched between the first and the second scrapable layers to prevent the information from being stolen or revealed.

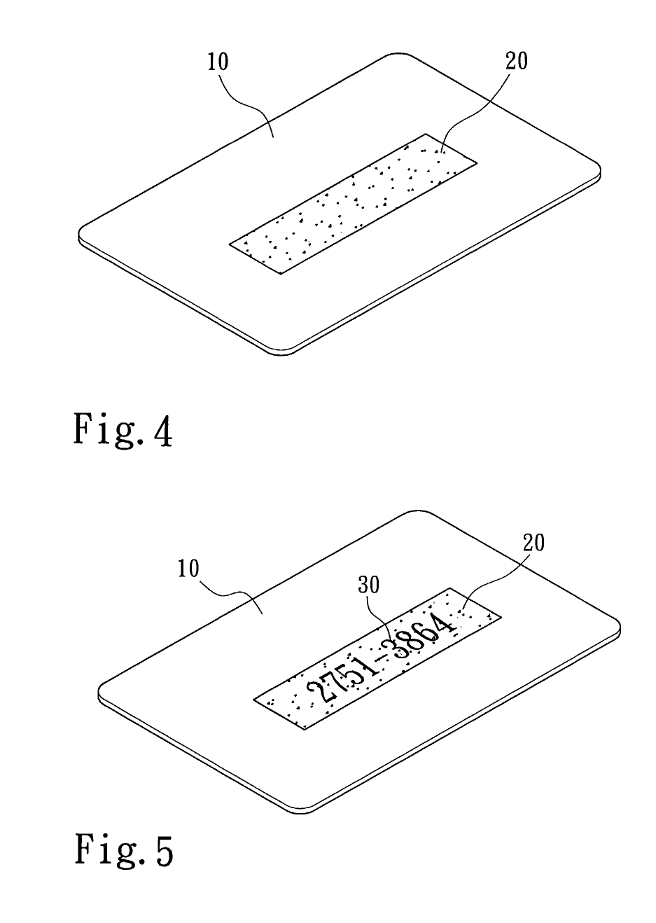

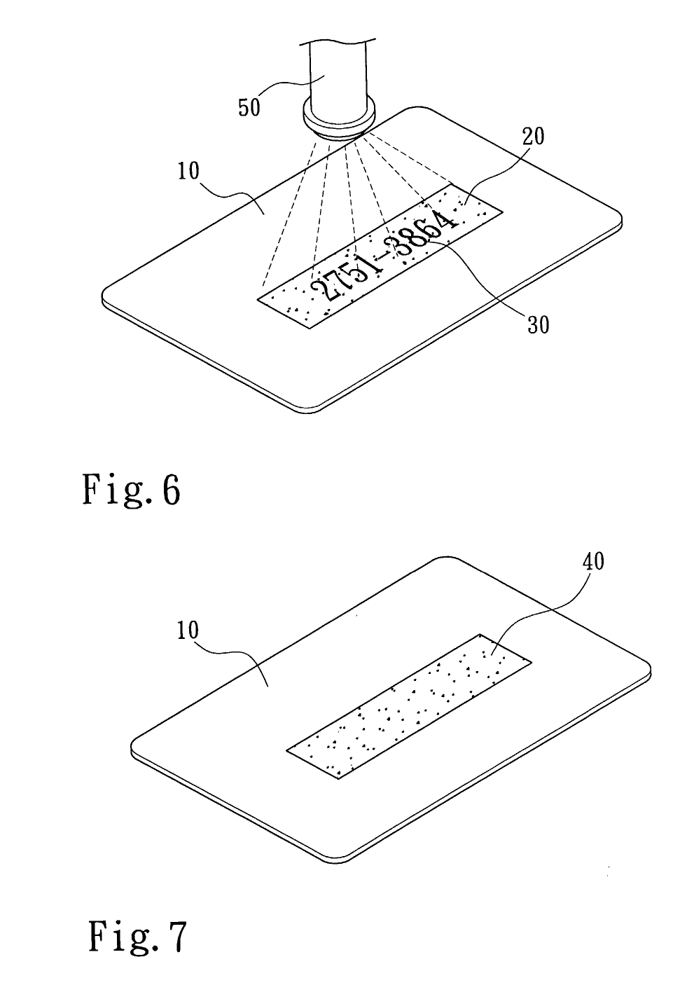

First, the first scrapable layer 20 (as shown in FIG. 4) is provided on the reserved position 11 of the card carrier 10, e.g. a conventional plastic card, and the confidential information 30 is printed on the first scrapable layer 20 (referring to FIG. 5); then a computer 50 automatically detects and checks the accuracy of the information 30 (as shown in FIG. 6) in lieu of the conventional human intervention; and last, the second scrapable label-layer 40 is stuck on the first scrapable layer 20 to cover the information 30 and the first scrapable layer 20 (as shown in FIG. 7.) In this way, the information 30 is enveloped and sandwiched between the first and the second scrapable layers 20, 40 to get the information 30 under safer and more confidential protection.

The second scrapable label-layer 40 is separated from the first scrapable layer 20 and the confidential information 30 by means of a plastic film, thereby, the confidential information 30 is well protected from being scraped off even it is subject to a strong scraping force. If someone intentionally using a knife along the outer rim of the second scrapable label-layer 40 to peek at the inside confidential information 30, the confidential information 30 is still well protected by its sandwich effect, i.e. the information printed on the first scrapable layer 20 and the other side of the confidential information 30 similarly sealed by the first scrapable layer 20. If the first scrapable layer 20 being forcedly scraped, the confidential information 30 directly onto the scrapable material will be also destroyed. Therefore, an improved protection is obtained.

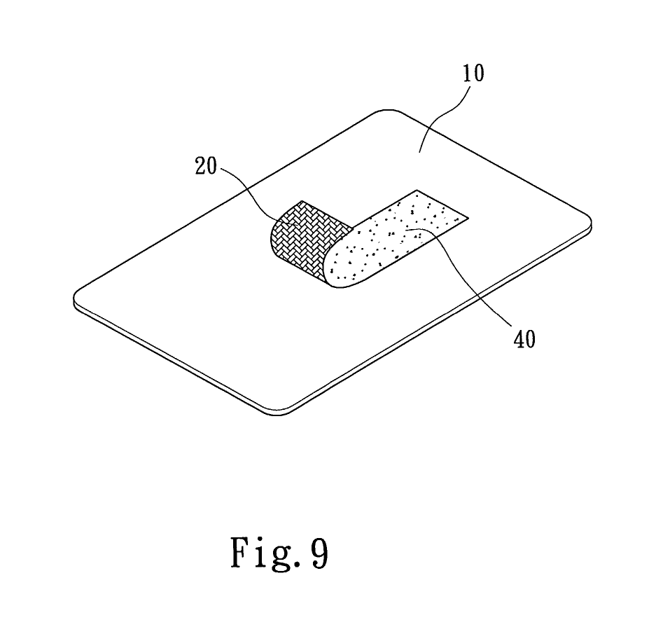

In practicing the present invention, the first scrapable layer 20 has an essential thickness of coating for its obscurity to get the information under safety and confidentiality; and even as shown in FIG. 9, the first scrapable layer 20 is further provided with visibility interference designs, e.g. drawings or words, to prevent seeing through, whereby the inside information 30 is prevented from being seen or revealed. The second scrapable label-layer 40 is equal or not equal in size to the first scrapable layer 20, and can be made by applying a scrapable layer on a transparent adhesive tape.

By such a method, a card is provided with a first scrapable layer provided at a reserved position on the card, or with a coating layer temporarily attached to and separable from the reserved position subject to any applied force. There is no worry about revealing the confidential information which has not been printed, and the scrapable label-layer stuck to the printed confidential information can be made by the present machine or equipment without any additional production costs. The first scrapable layer and the second scrapable label-layer can be produced on the same equipment. Therefore, cost of production can be largely reduced. Based on the above, the confidential information in the present invention has on the upper and the lower sides thereof scrapable layers to form a sandwiched structure, the information thereby is definitely in safer and more confidential protection.

According to the present invention, the stated sandwiched scrapable layer structure and the method for making the same overcome the defects of the conventional cards of being subjected to intentionally destroying and peeping of confidential information. A plastic film is provided so that the confidential information is separated from the first scrapable layer and the inside confidential information will not be scraped off when the second scrapable label-layer is forcedly scraped. Further, with another scrapable layer on the bottom of the confidential information, the confidential information is not revealed even when the second scrapable label-layer is cut. Therefore, the present invention improves safety and secrecy of the confidential information.

1. A method for making a sandwiched scrapable layer structure, said method includes the following steps:
1) a first scrapable layer in a form of scrapable materials or film is coated on a card carrier;
2) information is printed on said first scrapable layer;
3) a computer automatically detects and checks said information; and
4) a second scrapable layer in a label form is stuck on said first scrapable layer to cover said information.

2. A sandwiched scrapable layer structure comprising:
a card carrier with a reserved position for a scrapable layer;
a lower scrapable layer having an obscure surface to be directly coated on said reserved position for said scrapable layer;
a confidential information printed on said lower scrapable layer; and
an upper scrapable layer in a label form which is a transparent adhesive tape with an obscure surface for covering said confidential information and the top of said reserved position;
thereby, said information is tightly sealed and sandwiched between said first and said second scrapable layers to prevent said information from being stolen or revealed.

3. A sandwiched scrapable layer structure as in claim 2, wherein,
said lower scrapable layer is made obscure by its accumulated thickness of coating.

4. A sandwiched scrapable layer structure as in claim 2, wherein,
a surface of said lower scrapable layer confronting to said card carrier is provided with interference designs to prevent seeing through.

5. A sandwiched scrapable layer structure as in claim 2, wherein,
said upper scrapable label-layer is equal to said lower scrapable layer in size.

6. A sandwiched scrapable layer structure as in claim 2, wherein,
said upper scrapable label-layer is not equal to said lower scrapable layer in size.
